(19) United States
(12) Patent Application Publication
(10) Pub. No.: US 2010/0297872 A1
(43) Pub. Date: Nov. 25, 2010

(54) RELAY CONNECTOR FOR FPC USING ADHESIVE

(75) Inventor: Yuichi Hasegawa, Kanagawa (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/438,431

(22) PCT Filed: Aug. 23, 2007
(86) PCT No.: PCT/US2007/018658

§ 371 Date: Aug. 12, 2010

(30) Foreign Application Priority Data
Aug. 23, 2006 (JP) 2006-226885

(51) Int. Cl. H01R 12/10; H01R 12/24

(52) U.S. Cl. 439/499

(57) ABSTRACT

A relay connector for connecting together two free ends of flat flexible cable (FFC) is provided with an insulative housing that has a body portion with two open ends that receive free ends of the FFC. The housing includes a terminal assembly disposed in its mid-section and this terminal assembly includes a base with terminals embedded therein. The terminals extend length-wise through the base and have their body portions held by the terminal assembly base so that free ends of the terminals are free to deflect under pressure. The terminals are formed so that their free ends extend at a slight upward angle. A sheet of a thermoplastic adhesive is interposed between the terminal assembly and the housing. Free ends of the FFC are pressed into alignment with the terminal ends under heat and pressure so that the adhesive becomes plastic and flows between the terminals into contact with the FFC. Once the adhesive cools and solidifies, the two free ends of the FFC are connected together.

### BACKGROUND OF THE INVENTION

The present invention relates generally to FPC Connectors and more particularly to a relay connector for releasing joining together two length of FPC.

Conventionally, a relay connector for connecting together flat, flexible cables, which are usually referred to as flat flexible circuitry, flexible printed circuitry (FFC, FPC) and the like, has been proposed (as shown Japanese Unexamined Utility Model Application (Kokai) publication No. H5 (1993)-31167).

FIG. 8 is a perspective view of a prior art relay connector.

As is shown in the drawing FIG. 8, the relay connector has a housing 806 made of an insulating material such as a synthetic resin and a plurality of connecting terminals 807 made of a conductive material such as a metallic material and held in the housing 806. The connection terminals 807 are accommodated in holding grooves formed between a plurality of holding convex strips 811 formed in a bottom portion of the housing 806. The connecting terminal 807 includes an engagement opening 807a and is secured to the housing 806 when the engagement opening 807a is engaged with an engaging projection 816 projecting from the holding groove.

And, end portions of a pair of flat cables 801 are received in the housing 806. Each of the flat cables 801 includes a plurality of conductive wires 803 formed on one surface (a lower surface in the drawing) of a body portion 802 made of a strip-shaped insulating material and an insulating film covering a surface of the conductive wires 803. The insulating layer film is removed at an end portion of the flat cable 801 to expose the conductive wires 803 thereof. The flat cable 801 is also provided with positioning holes 818 formed therein so that the flat cable 801 is accommodated in the housing 806 when projections 813 formed in the housing 806 are brought into engagement with the positioning holes 818.

A cover 809 is swingably secured to the housing 806 so that, when the cover 809 is closed in a state where the end portions of the pair of flat cables 801 are accommodated in the housing 806, a pressing body or portion 814 mounted on an inner surface of the cover 809 presses against the flat cables 801. Hence, the conductive wires 803 of the flat cables 801 are pressed against connecting projections 807b of the terminals 807 by applying thereto cutting and raising operations, and accordingly an electrical connection is provided therebetween.

### SUMMARY OF THE INVENTION

In the described prior art relay connector, the connecting terminals 807 are accommodated in the holding grooves formed between a plurality of holding convex strips 811 formed in the bottom portion of the housing 806, the structure of the relay connector is complicated and must be large in size. In recent years, the pitches of the wires 803 of the flat cables 801 have been narrowed due to a progressive reduction in the sizes of electronic devices, it is necessary to narrow the pitches of the connecting terminals 807 in order to be fit to the pitches of the wires 803. In the relay connector of the described prior art, because the connecting terminals 807 are accommodated in the holding grooves, there is difficulty in narrowing the pitches of the connecting terminals 807 down to 0.1 [mm] or so, for instance.

It is therefore an object of the present invention to solve the above-described problems encountered in the prior art and to provide a relay connector including a housing having a bottom plate portion, mutually parallel side wall portions extending in a longitudinal direction of the bottom plate portion, and an accommodating space defined by the bottom plate portion and the side wall portions and opened in a direction opposite to the bottom plate portion, the accommodating space housing terminals therein, wherein the relay connector further includes an adhesive sheet, interposed between the terminals and the bottom plate portion. Such a connector is small in both size and thickness with a simple structure yet capable of easily and reliably connecting a flat cable thereto.

For this reason, a relay connector according to the present invention includes a housing accommodating the free ends of a pair of FPC cables and terminals extending longitudinally of the housing with an approximately axially symmetrical shapes relative to a straight line perpendicular to the longitudinal direction at a center of the longitudinal direction; the relay connector further including a terminal holding member integrally formed with a portion containing at least the center of the terminals in the longitudinal direction and mounted on the housing to hold a plurality of terminals; wherein the housing includes a bottom plate portion, mutually parallel side wall portions extending in a longitudinal direction of the bottom plate portion, and an accommodating space which is defined by the bottom plate portion and the side wall portions and is opened in a direction contrary to the bottom plate portion, the accommodating space accommodating therein the terminals, and an adhesive sheet being provided to be interposed between the terminals and the bottom plate portion.

In an another embodiment of the relay connector according to the present invention, the terminals includes base portions having at least a portion thereof covered by the terminal holding member and a contacting portion connected to a far end of the base portion, respectively; and the contacting portions being arranged to be tilted with respect to the bottom plate portion such that the closer to the far ends, the more the contacting portions are separated from the bottom plate portion.

In a further embodiment of the relay connector according to the present invention, the terminals are flexible and in the contacting portions are spaced away from the adhesive sheet.

In a further embodiment of the relay connector according to the present invention, the conductive wires of the FPC are exposed in at least a portion in the mating area at the free end of the flat cable, and the flat cable is accommodated in the connector accommodating space so that the wires thereof contact the corresponding connector terminals, are pressed against the bottom plate portion, and the adhesive is heated to be connected to the relay connector.

In a still further embodiment of the relay connector according to the present invention, the flat cable is bonded to the bottom plate portion with an adhesive contained in the adhesive sheet.

In accordance with the present invention, the relay connector has a housing including a bottom plate portion, mutually parallel side wall portions extending in a longitudinal direction of the bottom plate portion, and an accommodating space which is defined by the bottom plate portion and the side wall portions and is opened in a direction contrary to the bottom plate portion, the accommodating space accommodating therein terminals and an adhesive sheet being interposed between the terminals and the bottom plate portion. Hence, although the relay connector is small in its size and thickness while having a simple structure, the flat cable can be easily and surely connected thereto.

### BRIEF DESCRIPTION OF THE DRAWINGS

FIG. 1 is a perspective view of the relay connector according to the embodiment of the present invention;

FIG. 2 is an exploded view of an actuator of the relay connector according to the embodiment of the present invention;

FIG. 3 is a top plan view of the relay connector according to the embodiment of the present invention;

FIG. 4 is an elevation view of the relay connector according to the embodiment of the present invention, viewing along the line of arrow A-A in FIG. 3;

FIG. 5 is a cross-sectional view of the relay connector according to the embodiment of the present invention, taken along the line B-B of FIG. 3, illustrating a state immediately before connection of the flat cable to the relay connector;

FIG. 6 is a cross-sectional view of the relay connector according to the embodiment of the present invention, taken along the line B-B of FIG. 3, illustrating a state immediately after connection of the flat cable to the relay connector;

FIG. 7 is a perspective view of the relay connector according to the embodiment of the present invention, illustrating a state before and after connection of the flat cable to the relay connector; and

FIG. 8 is a perspective view of a relay connector according to the prior art.

### DESCRIPTION OF THE PREFERRED EMBODIMENTS

Throughout the drawing FIG.ures, reference numeral 1 designates a relay connector according to the embodiment of the present invention, which is used for connecting together a pair of flat cables 101 which will be described later. The flat cable 101 is a flexible flat cable referred to as a flexible circuit board flexible printed circuit (FPC) a flexible flat cable (FFC) and the like, and may be any type of flat cable as long as it has conductive wires.

In addition, in this embodiment, representations of directions such as up, down, left, right, front, rear, and the like, used for explaining the structure and movement of each part of the connector 1 are not absolute, but relative. These representations are appropriate when the connector 1 is in the position shown in the FIG.ures. If the position of the connector 1 changes, however, it is assumed that these representations are to be changed according to the change of the position of the connector 1.

The connector 1 has a flat housing 11 formed of an insulative material such as a plastic material such as PBT (polybutylene terephthalate), PC (polycarbonate), LCP (liquid crystal polymer), PPS (polyphenylsulfide), polyamide, PEEK (polyether-etherketone), or the like, and is molded such as by injection molding. It is preferred that the housing 11 is made of a high heat-resistant resin such as LCP.

The housing 11 includes a bottom plate portion 12 in the term of a rectangular plate member and it has mutually parallel side wall portions 13 disposed upright on both sides of the bottom plate portion 12 and extending longitudinally. It also has doorsill portions 15 for connecting end portions of the side wall portions 13 arranged on both sides of the housing 11. The plate portion 12, the side wall portions 13, and the doorsill portions 15 are preferably integrally formed together as one piece. Further, an accommodating space 16 is dispensed in the housing in a direction opposite the bottom plate portion 12 and is cooperatively defined by the bottom plate portion 12, the side wall portions 13, and the doorsill portions 15. In addition, the doorsill portion 15 is formed with a reduced thickness and disposed at a lower level than the side wall portions 13. Furthermore, engagement concave portions 14 are formed in a center of inner surfaces of the side wall portions 13 in a longitudinal direction.

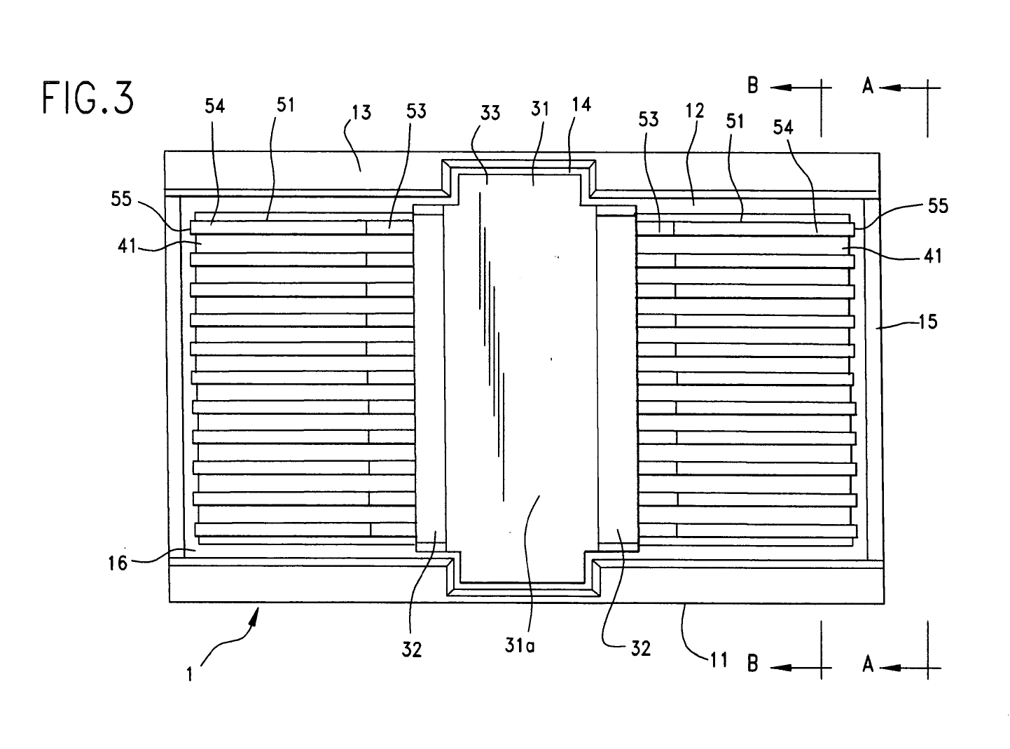

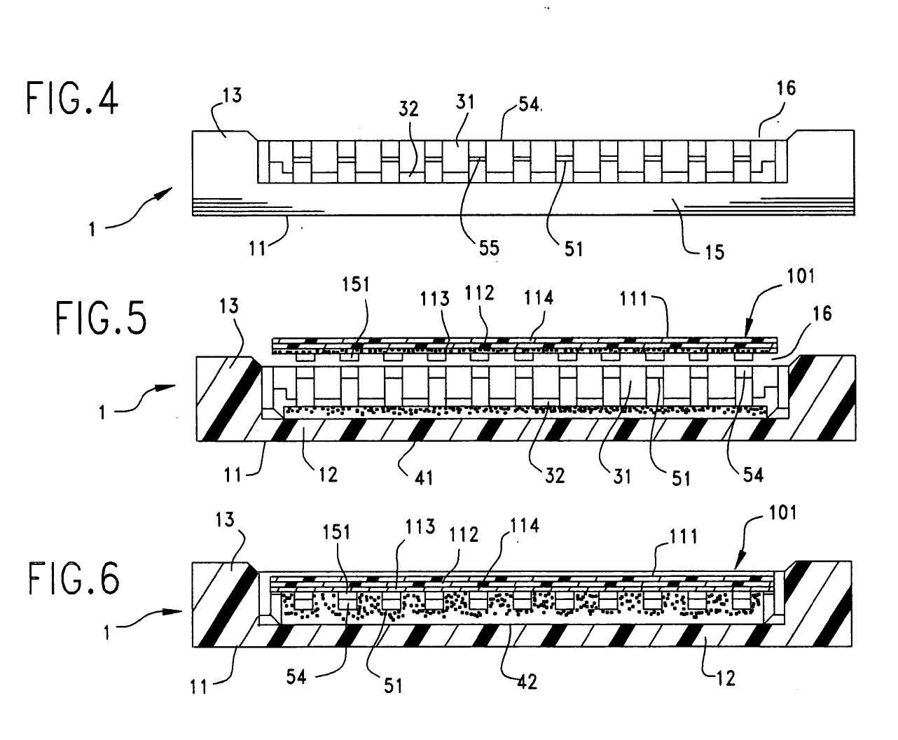

The terminals 51 extend longitudinally of the hosing 11, and are made of an elastic conductive material such as phosphor bronze or copper, and have an approximately axially symmetric shape with respect to a straight line perpendicular to the longitudinal direction at a center thereof, that is, a shape approximately axially symmetrical with respect to the right and left in FIG. 3. Base portions 53 are disposed at the middle of the terminals 51 and have around the center of the base portions 53, portions which are over-molded by a terminal holding member 31 also made of an insulating material. It is preferred that the terminal holding member 31 is formed of a high heat-resistant resin such as LCP for reasons to be explained. The terminals 51 are arranged in parallel with each other and are integrally held by the terminal holding member 31. Further, a distance between neighboring terminals 51, that is, a pitch of the terminals 51 is set around 0.1, for instance. In addition, the number and the pitch of the terminals 51 may be appropriately changed according to the number and the pitch of conductive wires 151 of the flat cable 101, which will be described later.

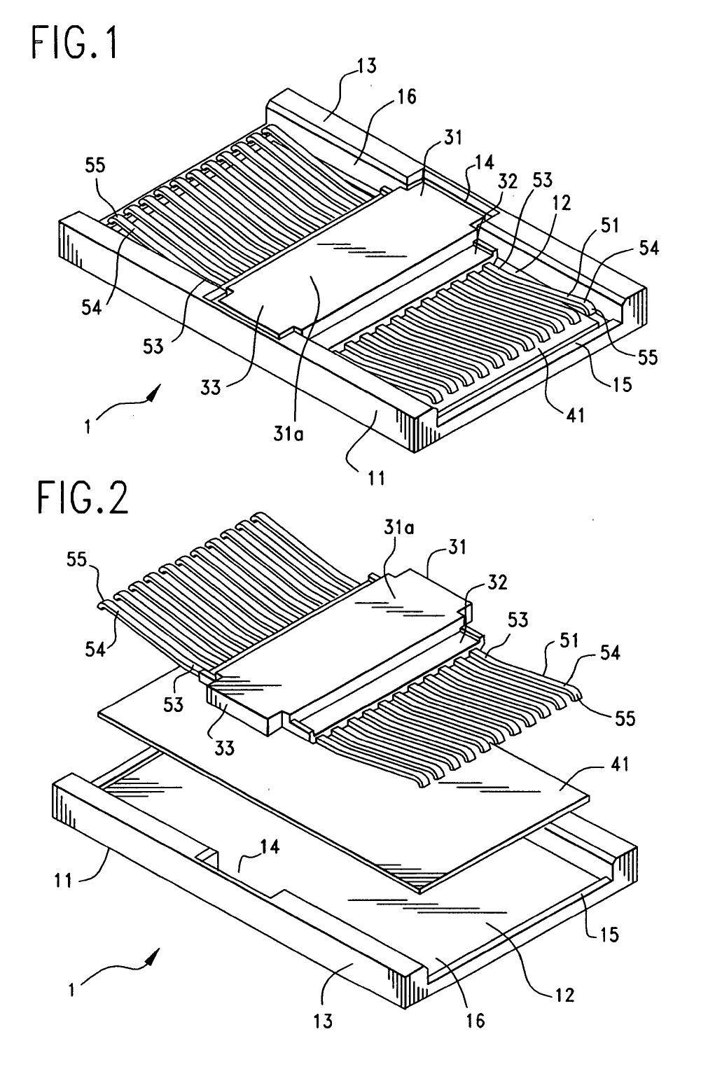

As illustrated in FIGS. 1 through 3, the terminals 51 extend for approximately the same length, respectively, with respect to right and left sides, of the terminal holding member 31, toward opposite ends of the housing 11 in the longitudinal direction. In this case, a portion of each of the terminal base portions thereof projects from the housing 11 and a tilting portion 54 which functions as a contacting portion is connected to the extreme end of the base portion 53, and further a tip portion 55 is connected to an end of the tilting portion 54. It is to be noted that each of the terminals 51 projecting from side to side is naturally connected by the common base portion 53 in the terminal holding member 31.

As illustrated in FIG. 1, the terminals 51 are held in the accommodating space 16 where the terminal holding member 31 is mounted on the housing 11. The terminal base portions 53 extend parallel to the upper surface of the bottom plate portion 12 and, the tilting portions 54 are tilted with respect to the upper surface of the bottom plate portion 12 such that the closer to the terminal free ends thereof, the more the tilting portions 54 are raised, and the tip portions 55 are curved such that the free end portion of each tip portion 55 faces downward. In other words, a portion of the terminals 51 projecting from the terminal holding member 31 has the shape of a tilting cantilever, one end of which is held by the terminal holding member 31, and the tip portions 55 positioned at free ends are placed in a state where these portions are spaced move away from the upper surface of the bottom plate portion 12.

In addition, the terminal holding member 31 has a thick, plate-like body portion 31a with an upper surface thereof of an approximately rectangular shape, thin cable receiving portions 32 projecting from the body portion 31a toward the opposite ends of the housing 11, and engagement ends 33, that project from the body portion 31a toward both ends of the housing 11 in a transverse direction. The engagement end 33 are fitted in and engaged with the engagement concave portions 14 in a state where the terminal holding member 31 is mounted in the housing 11, so that the terminal holding member 31 and the terminals 51 are in position relative to the housing 11.

The terminal holding member 31 and the terminals 51 are mounted on the housing 11 via an adhesive sheet 41 containing an adhesive. This adhesive sheet 41 is disposed on the bottom plate portion 12 of the housing 11 and the terminal holding member 31 is mounted on the housing 11 so that the terminal holding member 31 and its terminals 51 are positioned on and above the adhesive sheet 41. The adhesive sheet 41 is formed of a prepreg comprised of a matrix material such as glass fibers impregnated with a thermoplastic adhesive such as a vinyl acetate resin system adhesive, an acrylic resin system adhesive, a vinyl chloride-vinyl acetate copolymer system adhesive, and a polyamide adhesive, for instance, however, the adhesive sheet 41 may be made of any material as long as it includes a thermoplastic adhesive. The adhesive sheet 41 has a rectangular shape, but, is slightly smaller in its size than the upper surface of the bottom plate portion 12. It is accommodated in the accommodating space 16 defined by the bottom plate portion 12, the side wall portions 13, and the threshold portions 15.

As illustrated in FIGS. 1-3, the adhesive sheet 41 is interposed between the bottom plate portion 12 and both the terminal holding member 31 and its terminals 51. The adhesive sheet 41 has a bonding property even in a stage prior to hardening the adhesive like a normal prepreg, at least the terminal holding member 31 is bonded to the bottom plate portion 12 via the adhesive sheet 41. The terminal tilting portions 54 and the tip portions 55 can be moved up and down because they are distant away from the adhesive sheet 41.

Next, the operation of connecting the flat cable 101 to the connector 1 will be explained.

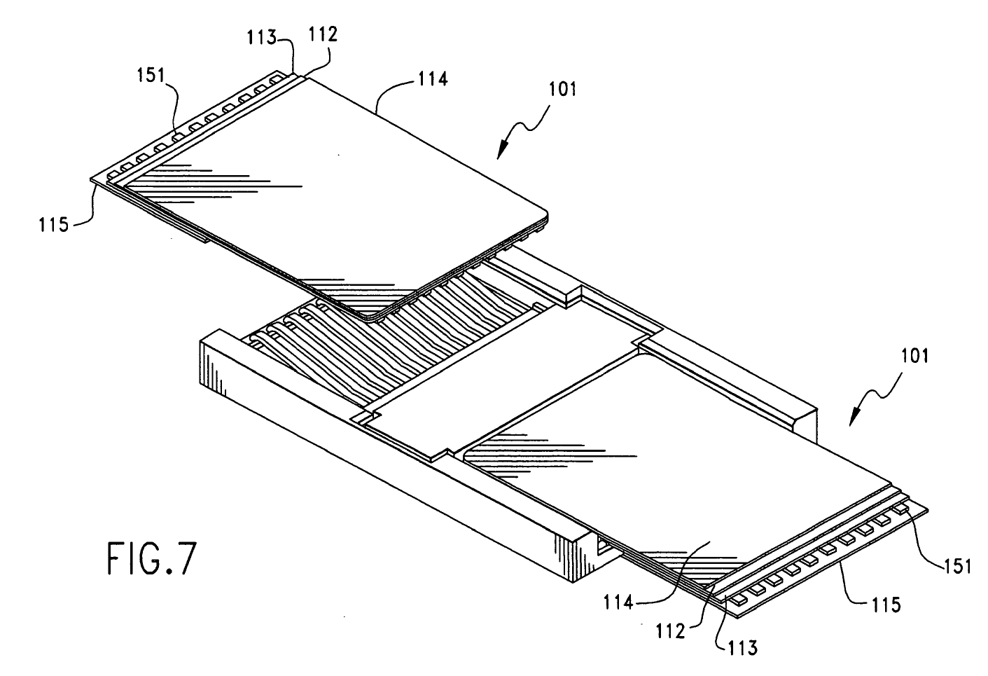

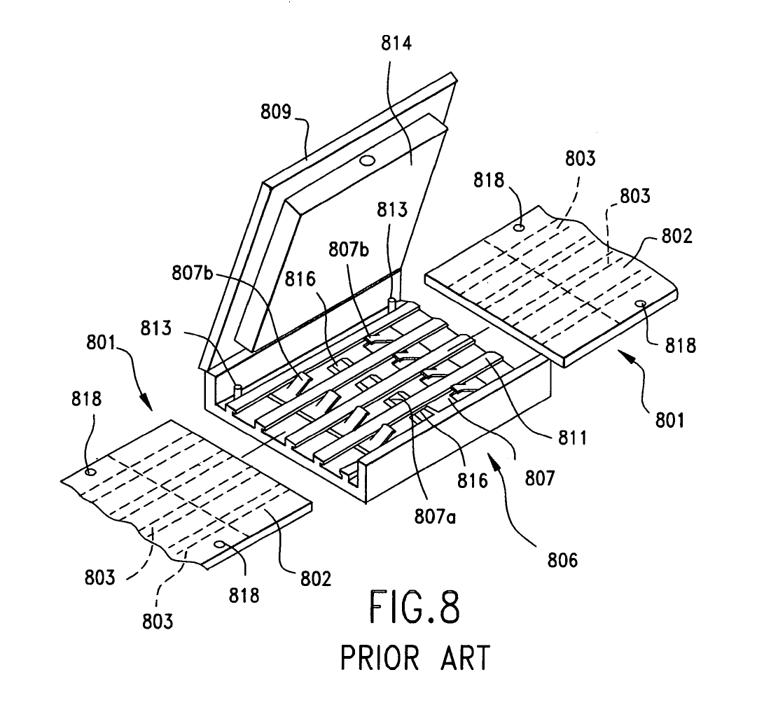

FIG. 5 is a cross-sectional view of the relay connector according to the embodiment of the present invention, taken along the line B-B of FIG. 3, illustrating a state immediately before connection of the flat cable to the relay connector; FIG. 6 is a cross-sectional view of the relay connector according to the embodiment of the present invention, taken along the line B-B of FIG. 3, illustrating a state immediately after connection of the flat cable to the relay connector; and FIG. 7 is a perspective view of the relay connector according to the embodiment of the present invention, illustrating a state before and after connection of the flat cable to the relay connector.

As illustrated in FIG. 5, the flat cable 101 includes a substrate portion 111 that is an insulative thin-sheet member having a long strip-like shape and a plurality of conductive wires 151 disposed on one surface thereof (lower surface in the drawing FIG.ure) of the substrate portion 111. The conductive wires 151 are typically flat lines made of conductive metal such as copper, and are arranged in parallel with one another at a predetermined pitch of 0.1 or so, for instance. The number and the pitch of the lead wires 151 can be appropriately changed, if necessary.

The substrate portion 111 includes a laminated base film 112, an adhesive layer 113, and a covering film 114. The base film 112 and the covering film 114 are made of a resin such as polyimide and polyester, for instance, and are preferably made of a heat-resistant resin. In addition, the adhesive layer 113 is an adhesion layer provided for bonding the base film 112 and the conductive wires 151 together.

It is preferable that a surface of the conductive wire 151 on the side opposite to the substrate portion 111 is covered by an insulating protective film 115 and the protective film is removed only at a free end portion of the flat cable 101, as illustrated in FIG. 7, and the conductive wires 151 are exposed, as illustrated in FIGS. 5 and 7.

When connecting the flat cable 101 to the connector 1, first, as illustrated in FIG. 5, the flat cable 101 is positioned so that its free end portion is positioned above the connector 1, and its conductive wires 151 confront the bottom plate portion 12, and the direction in which the cable's conductive wires 151 extend coincides with the direction of the extent of the terminals 51.

For instance, in FIG. 3, the flat cable 101 connected to the right side portion of the connector 1 is positioned above the terminals 51 on the right side so that the end face of the flat cable 101 is directed toward the left, and the same free end of the flat cable 101 is nearly in registration with the boundary line between the body portion 31a of the terminal holding member 31 and the cable receiving portion 32 on the right side, and both side surfaces of the flat cable free ends are nearly abutting the inner surfaces of the side wall portions 13 arranged on both sides.

In FIG. 3, the flat cable 101 to be connected to a left side portion of the connector 1 is positioned above the terminals 51 on the left side in such a manner that the end face of the flat cable 101 is directed to the right and the same end face of the flat cable 101 is nearly in registration with the boundary line between the body portion 31a of the terminal holding member 31 and the cable receiving portion 32 on the left side of the terminal holding newer, and both side faces of the flat cable free ends are nearly abutting the inner surfaces of the side wall portions 13 arranged on both sides.

It is to be noted that as illustrated in FIG. 5, the flat cable 101 is positioned such that each conductive wire 151 of the flat cable 101 confronts the corresponding terminal 51 of the connector.

Subsequently, from a state illustrated in FIG. 5, the flat cable 101 is moved downward in order to press against the bottom plate portion 12 of the housing 11. In this case, as in normal thermocompression bonding, the flat cable 101 is pressed against the housing 11 while being heated. Hence, the thermoplastic adhesive contained in the adhesive sheet 41 is heated and becomes platic.

When the flat cable 101 is moved downward, the flat cable 101 is positioned by moving the end face of the flat cable 101 along the boundary surface between the body portion 31a and the cable receiving portion 32 of the terminal holding member 31. The flat cable 101 with respect to the width direction relative to the housing 11 is positioned by moving both sides of the end portion of the flat cable 101 along the inner surfaces of the both side wall portions 13. Thus, each conductive wire 151 of the flat cable 101 reliably comes into contact with the corresponding terminal 51.

As described above, a portion of each of the terminals 51 projects from the terminal holding member 31 and has a shape of an oblique cantilever with the terminal tip portions 55 being widely spaced above the upper surface of the bottom plate portion 12. Therefore, when the flat cable 101 is moved downward, first, the terminal tip portions 55 or a portion near the tip of the tilting portions 54 contact with the conductive wires 151 of the flat cable 101. Subsequently, when the flat cable 101 is moved further downward, the terminals 51 are resiliently displaced by being pressed downward by the conductive wires 151. When pressure is applied on the flat cable 101 and the cable 101 is pressed against the bottom plate portion 12 of the housing 11, the terminals 51 will deflect to the extent that the terminal tilting portions 54 become nearly parallel to the upper surface of the bottom plate portion 12.

In this condition, the terminals 51 are pressed up wordly against the conductive wires 151 by their own flexibility. Therefore, each terminal 51 and the corresponding conductive wire 151 reliably contact each other and form a connection. In addition, since the terminal tilting portions 54 are nearly parallel to the upper surface of the bottom plate portion 12, nearly the entire tilting portions 54 contact the cable conductive wires 151. Therefore, since each terminal 51 and its corresponding conductive wire 151 contact each other in a large area, electrical connection of the terminals 51 and the conductive wires 151 is reliably established.

By heating the flat cable 101 and the housing 11, the thermoplastic adhesive contained in the adhesive sheet 41 is heated until plastic, and the plasticized adhesive flows and to passes through and between the terminals 51 and flows into portions between the flat cable 101 and the bottom plate portion 12 to form an integrated together. As illustrated in FIG. 6, an adhesive filling layer 42 is thus formed. The adhesive filling layer 42 includes the thermoplastic adhesive and the adhesive sheet 41, and when heating is stopped, the adhesive filling layer 42 cools and solidifies, and maintains a shape shown in the right side in FIGS. 6 and 7. In this instance, the flat cable 101 is bonded to the bottom plate portion 12 via the adhesive filling layer 42.

The adhesive filling layer 42 is made of the thermoplastic adhesive flowing into portions between the flat cable 101 and the bottom plate portion 12, so that every gap formed is filled with the thermoplastic adhesive even if the shape of the lower surface of the flat cable 101 and the upper surface of the bottom plate portion 12 are complicated. For this reason, as illustrated in FIG. 6, the adhesive filling layer 42 surrounds the periphery of each of the conductive wires 151 and the terminals 51 as well as coming into each portion between the neighboring conductive wires 151 in the lower surface of the flat cable 101 to be bonded with the adhesive layer 113. Thus, the flat cable 101 bonds to the bottom plate portion 12 and contact between the conductive wires 151 and the terminals 51 is reliably maintained. In addition, since the conductive wires 151 and the terminals 51 are surrounded by the adhesive filling layer 42, contact between the conductive wires 151 and the terminals 51 is reliably maintained even if the terminals 51 are less flexible. In other words, even if the upward urging force generated by the flexibility of the terminals 51 themselves is weak, contact is maintained.

Further, since the end face of the flat cable 101 is moved along the boundary surface between the body portion 31a and the cable receiving portion 320 of the terminal holding member 31, the flat cable 101 is bonded to the bottom plate portion 12 so that an area of the flat cable 101 having a predetermined length from the end face is positioned on the cable receiving portion 32. Therefore, the terminal holding member 31 will be in a state of being pressed against the bottom plate portion 12 from above by the flat cable 101 and is reliably held in the housing 11.

As described above, when the flat cables 101 are connected to the right side portion and the left side portion of the connector 1, the conductive wires 151 of each flat cable 101 and the terminals 51 will be electrically connected to each other, and therefore, the conductive wires 151 of both of the flat cables 101 are electrically connected to each other via the terminals 51.

Disconnection of the connector 1 and the flat cable 101 can be achieved by heating the flat cable 101 and the housing 11. Until the thermoplastic adhesive plastic and, the flat cable 101 bonded to the bottom plate portion 12 via the adhesive layer 42 can be separated apart from the bottom plate portion 12 at the connector. At least a portion of the thermoplastic adhesive contained in the adhesive filling layer 42 remains on the bottom plate portion 12 together with the adhesive sheet 41 even after the flat cable 101 is removed from the bottom plate portion 12. As a result, as with the connector 1 prior to connecting to the flat cables 101, the flat cable 101 can be again connected to the connector 1 by applying pressure and heat to the flat cables 101 and the housing 11.

As described above, the connector 1 according to the embodiment of the present invention includes the housing 11 for accommodating at least a predetermined area from an end of a pair of flat cables 101 and the terminals 51 having an approximately axially symmetrical shape relative to a straight line perpendicular to a longitudinal direction in a center thereof, and further includes the terminal holding member 31 integrally formed with a portion of the terminals 51 including at least a center of the terminals 51 in the longitudinal direction and mounted on the housing 11 while holding a plurality of terminals 51, whereas the housing 11 includes the bottom plate portion 12, the mutually parallel side wall portions 13 extending in a longitudinal direction of the bottom plate portion 12, and the accommodating space 16 defined by the bottom plate portion 12 and the side wall portions 13 and opened in a direction contrary to the bottom plate portion 12, wherein the terminals 51 are accommodated in the accommodating space 16 and the adhesive sheet 41 is interposed between the terminals 51 and the bottom plate portion 12.

Accordingly, the terminals 51 can be made very thin and the pitches of the terminals 51 can be narrowed. In addition, the size and thickness of the connector 1 can be reduced. Further, although the structure of the connector 1 is simple, a pair of flat cables 101 can be easily and surely connected to the connector 1.

In addition, the terminals 51 have base portions 53, at least a portion thereof is covered by the terminal holding member 31 and the tilting portions 54 connected to the end of the base portions 53, wherein the tilting portions 54 are tilted with respect to the bottom plate portion 12 such that the closer to their end, the more the tilting portions 54 are separated apart from the bottom plate portion 12, the terminals 51 are flexible, and at least the tilting portions 54 are separated apart from the adhesive sheet 41.

Hence, the tilting portions 54 of the terminals 51 can be moved up and down. Further, the terminals 51 are pressed against the conductive wires 151 of the flat cable 101 by upward urging force generated by its own flexibility. Therefore, each terminal 51 and the corresponding conductive wire 151 reliably contact each other.

Further, the flat cable 101 has conductive wires 151 which are exposed at least a portion in a predetermined area from the end of the flat cable 101 to lie in a flat plane, and is accommodated in the accommodating space 16 in such a manner that the conductive wires 151 may come into contact with the corresponding terminals 51, and may be pressed against the bottom plate portion 12 to be connected to the connector 1 by being heated.

Therefore, the flat cables 101 can be connected to the connector in an identical method to the normal thermocompression and therefore, a connection work can be easily performed.

Further, the flat cable 101 is bonded to the bottom plate portion 12 with the adhesive contained in the adhesive sheet 41.

Therefore, no soldering is required for connecting the flat cable 101 and thus, heating at high temperature for reflow of soldering is not required either. Accordingly, the connector 1 may never be thermally deformed.

The present invention is not limited to the above-described embodiments, and may be changed in various ways based on the gist of the present invention, and these changes are not eliminated from the scope of the present invention.

What is claimed is:

1. A connector comprising:
a housing for receiving a predetermined extent from an end of each of a pair of flat flexible cables, and
a plurality of terminals arranged to extend longitudinally within the housing,
a terminal holding member for holding of the terminals longitudinally within the housing,
the housing including a bottom plate portion parallel side wall portions extending longitudinally along the bottom plate portion, and an accommodating space defined by the bottom plate portion and the side wall portions;
said terminals being received in the accommodating space; and
thermoplastic adhesive sheet is interposed between said terminals and said bottom plate portion.

2. The connector according to claim 1, wherein each of said terminals respectively include a base portion having at least a portion thereof engaged by the terminal holding member and a contacting portion connected to an end of the terminal base portion and the contacting portion is tilted upward with respect to said housing bottom plate portion such that the closer to tip of free end of the terminal, the greater the contacting portions are spaced from said housing bottom plate portion.

3. The connector according to claim 2, wherein said terminals are flexible, and said terminal contacting portions are spaced from said adhesive sheet.

4. The connector according to claim 1, wherein said flat cable includes a plurality of conductive wires exposed at in the predetermined end extent, and said flat cable is received accommodated in said housing accommodating space in such a manner that the flat cable wires contact corresponding terminals of said connector, and are pressed against the bottom plate portion.

5. The connector according to claim 4, wherein said flat cable is bonded to said housing bottom plate portion with an adhesive contained in said adhesive sheet.

6. A connector for connecting two lengths of flexible printed circuits together, the connector comprising:
an insulative housing, the housing having a pair of side walls spaced apart from each other to define a central channel disposed therein, the channel extending longitudinally between two opposing end portions of said housing, the housing further including a bottom;
a plurality of conductive terminals supported in the housing channel, the terminals extending longitudinally within said housing channel, the terminals having respective free ends with contact portions disposed thereon at opposite ends of said terminals;
a thermoplastic adhesive layer disposed in said housing channel and disposed between said housing bottom and said terminals.

7. The flexible printed circuit connector of claim 1, further including a terminal holding member extending transversely between said side walls and each of said terminal contact portions extends upwardly away from said housing bottom.

8. The flexible printed circuit connector of claim 7, wherein said terminals are spaced apart from each other widthwise along said terminal holding member and between said housing side walls such that adjacent terminals are separated by intervening spaces.

9. The flexible printed circuit connector of claim 6, wherein said terminals are deflectable and said terminal contact portions are spaced away from and above said adhesive layer.

10. The flexible printed circuit connector of claim 8, wherein said adhesive layer includes a thermoplastic adhesive layer having a thickness sufficient to flow into the intervening spaces disposed between adjacent terminals when subjected to heat and pressure.

11. The flexible printed circuit connector of claim 7, wherein said housing side walls include slots disposed therein on opposite sides of said housing channel, and said terminal holding member including opposing ends that are received within the slots.

12. The flexible printed circuit connector of claim 7, wherein said terminal holding member includes a pair of shoulders, on opposite longitudinal ends of said terminal holding member for respectively receiving free ends of said flexible printed circuit lengths.

13. The flexible printed circuit connector of claim 6, further including:
two lengths of flexible printed circuits, each of said flexible printed circuit lengths including a plurality of conductive wires extending therethrough, free ends of the wires being exposed for a lengthwise extent, proximate to free ends of the flexible printed circuit lengths, the flexible printed circuit free ends being received in said housing channel, on opposite sides of said terminal holding member such that the flexible printed circuit exposed wires contact corresponding terminals.

14. The flexible printed circuit connector of claim 13, further including a terminal holding member extending transversely between said side walls and each of said terminal contact portions extends upwardly away from said housing bottom, the terminal holding member including a pair of shoulders disposed on opposite longitudinal ends thereof, each of the terminal holding member shoulders receiving a free end of one of said flexible printed circuit lengths.

15. The flexible printed circuit connector of claim 13, wherein said terminals are supported by a terminal holding member extending transversely between said housing side walls, said terminals having body portions held by said terminal holding member and free ends that extend outwardly from said terminal holding member in a cantilevered fashion.

16. The flexible printed circuit connector of claim 13, wherein said flexible printed circuit length free ends are bonded to said housing bottom by the adhesive of said adhesive layer.

17. The flexible printed circuit connector of claim 15, wherein said terminal are spaced apart from each other widthwise along said terminal holding member and adjacent ones of said terminals are separated from each other by intervening spaces, said intervening spaces being filled with said adhesive.

18. The flexible printed circuit connector of claim 3, wherein said adhesive is a thermoplastic adhesive.
